(19) United States
(12) Patent Application Publication
(10) Pub. No.: US 2015/0260337 A1
(43) Pub. Date: Sep. 17, 2015

(54) OIL SUCTION DEVICE

(71) Applicant: I-SIN PENG, Taichung (TW)

(72) Inventor: I-SIN PENG, Taichung (TW)

(21) Appl. No.: 14/727,652

(22) Filed: Jun. 1, 2015

Related U.S. Application Data
(63) Continuation of application No. 14/146,789, filed on Jan. 3, 2014.

(51) Int. Cl. F16N 37/00; F17D 1/14

(52) U.S. Cl. CPC F16N 37/00; F17D 1/14; F16N 2037/006

(57) ABSTRACT

An oil suction device is disclosed and comprises a container and a plurality of movable fasteners. An oil supply pump and a connection pipe can be directly accommodated in a first accommodation trough and a second accommodation trough of a container respectively to be taken along with the container anytime. And because the oil is flowed from the small diameter section to the large diameter section, the outlet pressure of the oil from the large diameter section may be larger and the dust may be not accumulated in the connection pipe easily. Through the movable fastener which is disposed on the container and can be detached to two pieces, the power cord of the oil supply pump is detachably fixed by the simplified structure and operation. It is convenient for use and storage. The oil suction device has a simplified structure and the operation of the oil suction device is convenient.

### FIELD OF THE INVENTION

The present invention relates to an oil suction device, and more particularly to an oil suction device having a container with a first accommodation trough for accommodating an oil pump and a second accommodation trough for accommodating a connection pipe and a plurality of movable fasteners.

### BACKGROUND OF THE INVENTION

A container is used to accommodate liquid (such as oil or water) for storage. When the liquid (such as oil) is sucked from an oil supply object (such as an engine) to the container, one end of an oil pipe is inserted to the oil supply object and the other end thereof is connected with an inlet of an oil pump and then an outlet of the oil pump is connected with the container so that the liquid is sucked from the oil supply object to the container through the oil pump for saving time.

However, the container and the oil pump are two different objects and they are not convenient to carry around. And it is hard to arrange the two objects due to large volume. Furthermore, a user needs carry the two big objects by two hands with inconvenience.

That is, not every place has an oil supply pump. If the oil supply pump is required, the user has to take the oil supply pump along. The oil supply pump occupies a space and can't be stored easily.

Accordingly, the inventor of the present invention has devoted himself based on his many years of practical experiences to solve this problem.

### SUMMARY OF THE INVENTION

The primary object of the present invention is to provide an oil suction device. An oil supply pump and a connection pipe can be directly accommodated in a first accommodation trough and a second accommodation trough of a container respectively to be taken along with the container anytime. And because the oil is flowed from the small diameter section to the large diameter section, the outlet pressure of the oil from the large diameter section may be larger and the dust may be not accumulated in the connection pipe easily. Through the movable fastener which is disposed on the container and can be detached to two pieces, the power cord of the oil supply pump is detachably fixed by the simplified structure and operation. It is convenient for use and storage. The oil suction device of the present invention has a simplified structure and the operation of the oil suction device is convenient.

In order to achieve the above object, the bucket of the present invention may comprise a container, outside of the container having a first accommodation trough for accommodating an oil supply pump and a second accommodating trough for accommodating a connection pipe, an outlet of the oil supply pump is fluidly communicated with an inside of the container and an inlet thereof is fluidly communicated with the connection pipe; and a plurality of movable fasteners, each movable fastener having a male buckle and a female buckle to engage with each other, the male buckle being fixed on one side of the container close to the accommodation trough, the male buckle having a first base and a plurality of protrusions, each protrusion extending upward from a central portion of the first base, the protrusions being spaced at an equal angle, one end of each protrusion, opposite to the first base, being formed with a tapered shoulder, the female buckle having a second base, an annular buckle and a holding member, the second base having an opening for insertion of the protrusions of the male buckle, the tapered shoulder of each protrusion being detachably connected to the opening, one end of the annular buckle being fixed to one side of the second base, another end of the annular buckle being suspended and formed with a first hook, the holding member being disposed on the second base, close to the first hook of the annular buckle, one side of the holding member, close to the first hook, having a second hook, the first hook being detachably engaged with the second hook.

In some embodiments, the annular buckle of the male buckle is detachable for fixing at least one power cord of the oil supply pump and an oil pipe.

In some embodiments, wherein the connection pipe includes a large diameter section and a small diameter section fluidly communicated with each other, one end of the large diameter section opposite to the small diameter section is fluidly communicated with the inlet of the oil supply pump and the other end thereof opposite to the oil pump is fluidly communicated with the small diameter section.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is an exploded view of an oil suction device according to present invention.

FIG. 2 is a perspective view of the oil suction device according to present invention.

FIG. 3 is an exploded view of a connection pipe of the oil suction device according to present invention.

FIG. 4 is an exploded view of a movable fastener of the oil suction device according to present invention.

FIG. 5 is a perspective view of the movable fastener of the oil suction device according to present invention.

FIG. 6 is an assembled sectional view of the movable fastener of the oil suction device according to present invention.

FIG. 7 is a sectional view showing engagement of an annular buckle and a holding member of the movable fastener of the oil suction device according to present invention.

### DESCRIPTION OF THE PREFERRED EMBODIMENT

Referring now to the drawings where like characteristics and features among the various figures are denoted by like reference characters.

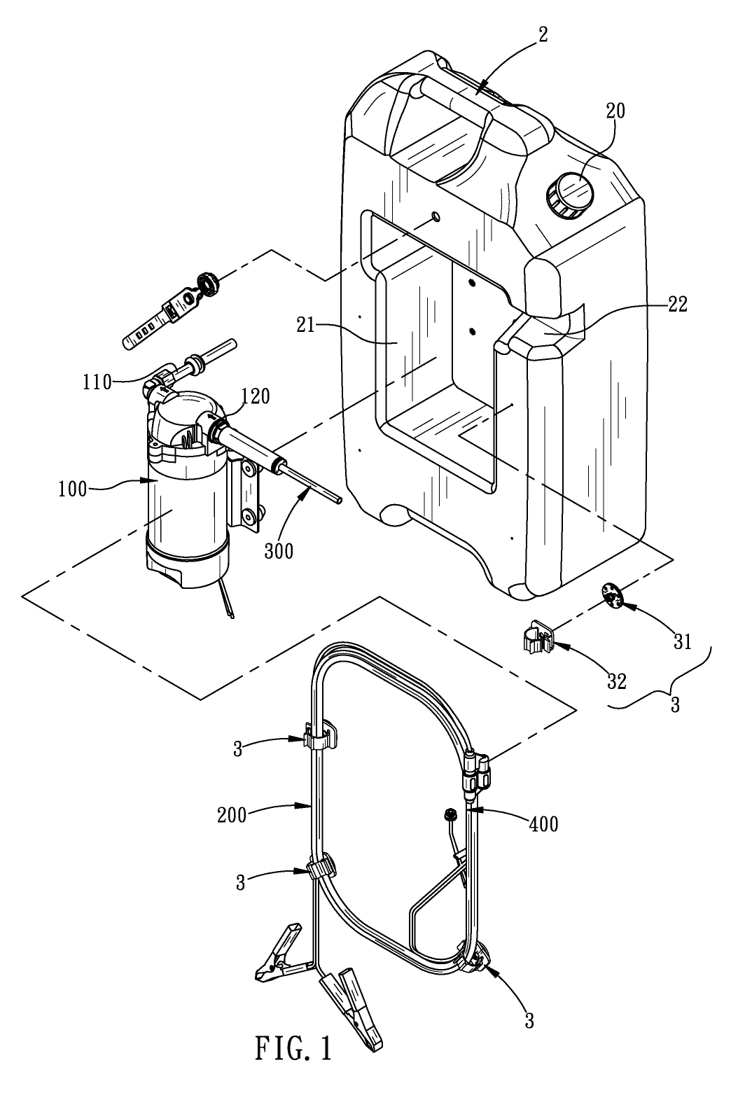

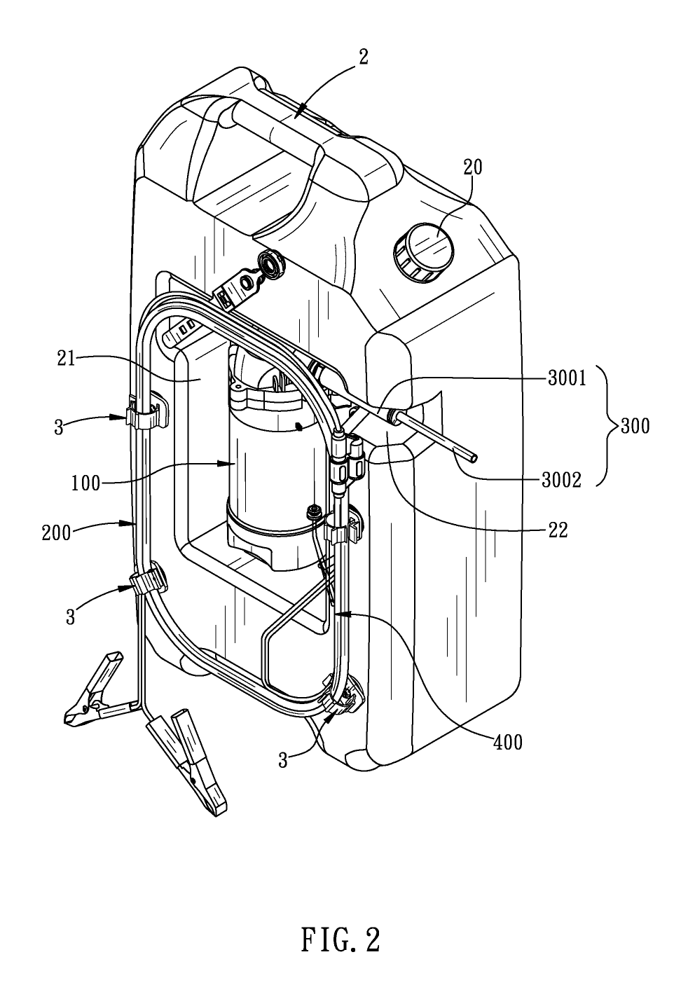

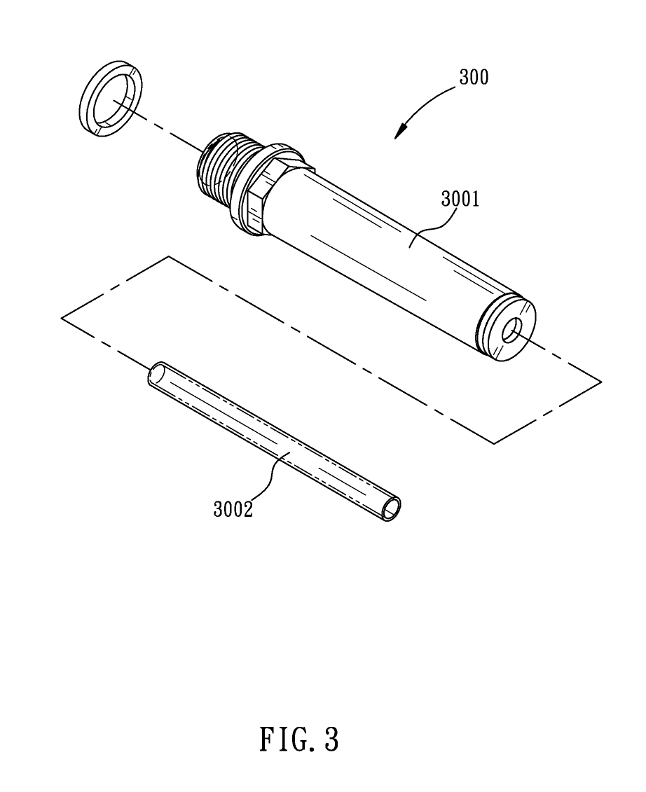

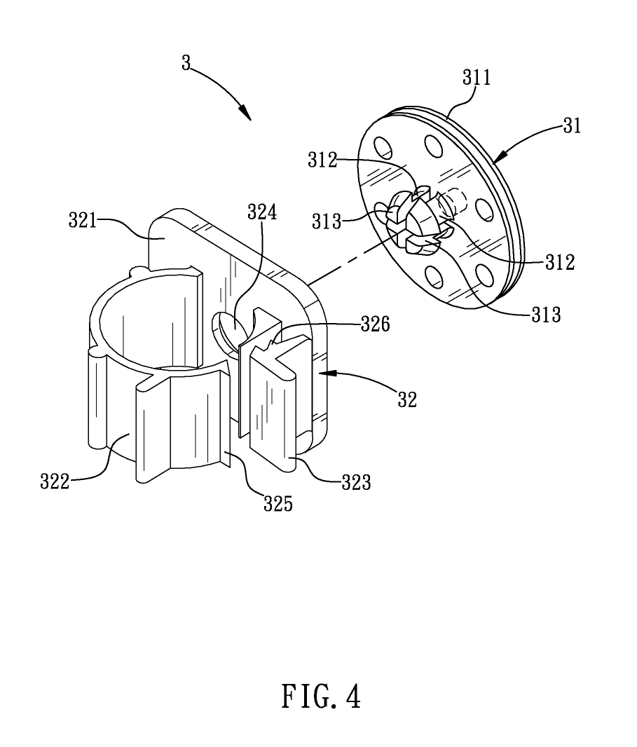

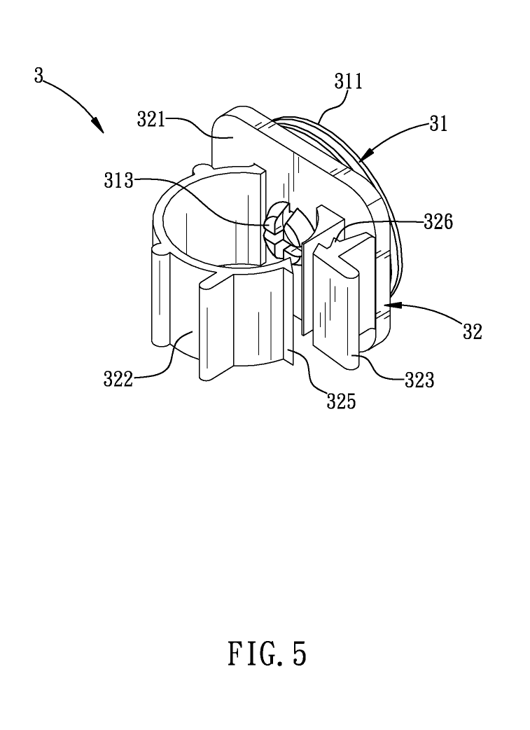

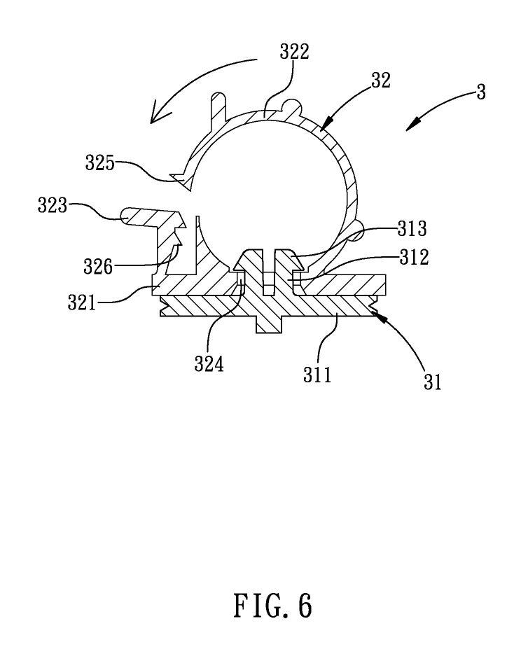

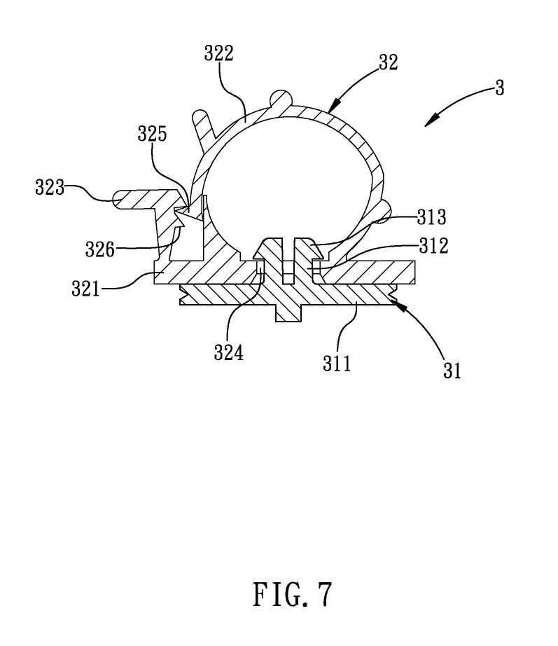

FIG. 1 is an exploded view of an oil suction device according to present invention. FIG. 2 is a perspective view of the oil suction device according to present invention. FIG. 3 is an exploded view of a connection pipe of the oil suction device according to present invention. FIG. 4 is an exploded view of a movable fastener of the oil suction device according to present invention. FIG. 5 is a perspective view of the movable fastener of the oil suction device according to present invention. FIG. 6 is an assembled sectional view of the movable fastener of the oil suction device according to present invention. FIG. 7 is a sectional view showing engagement of an annular buckle and a holding member of the movable fastener of the oil suction device according to present invention.

Please refer to FIGS. 1 to 7, the oil suction device 1 of the present invention comprises a container 2 and a plurality of movable fasteners 3.

The container 2 is a hollow container and has an opening 20. Outside of the container 2 has a first accommodation trough 21 for accommodating an oil supply pump 100 and a second accommodation trough 22 for accommodating a connection pipe 300. An outlet 110 of the oil supply pump 100 may be fluidly communicated with an inside of the container 2 and an inlet 120 thereof may be fluidly communicated with the connection pipe 300. The connection pipe 300 includes a large diameter section 3001 and a small diameter section 3002 fluidly communicated with each other. One end of the large diameter section 3001 opposite to the small diameter section 3002 may be fluidly communicated with the inlet 120 of the oil supply pump 100 and the other end thereof is fluidly communicated with the small diameter section 3002.

Each movable fastener 3 has a male buckle 31 and a female buckle 32 to be engaged with each other. The male buckle 31 is fixed on one side of the container 2 close to the accommodation trough 21. The male buckle 31 has a first base 311 and a plurality of protrusions 312. Each protrusion 312 extends upward from the central portion of the first base 311. The protrusions 312 are spaced at an equal angle. One end of each protrusion 312, opposite to the first base 311, is formed with a tapered shoulder 313. The female buckle 32 has a second base 321, an annular buckle 322, and a holding member 323. The second base 321 has an opening 324 for insertion of the protrusions 312 of the male buckle 31. The tapered shoulder 313 of each protrusion 312 is detachably connected to the opening 324. One end of the annular buckle 322 is fixed to one side of the second base 321, and another end of the annular buckle 322 is suspended and formed with a first hook 325. The holding member 323 is disposed on the second base 321, close to the first hook 325 of the annular buckle 322. One side of the holding member 323, close to the first hook 325, has a second hook 326. The first hook 325 is detachably engaged with the second hook 326.

Furthermore, the annular buckle 322 is detachable for fixing at least one power cord 200 and/or an oil pipe 400. The oil pipe 400 may be fluidly communicated with the small diameter section 3002 of the connection pipe 300 while in use.

Through the above mentioned structure, the oil supply pump 100 and the connection pipe 300 can be directly accommodated in the first accommodation trough 21 and the second accommodation trough 22 of the container 2 respectively to be taken along with the container 2 anytime. And because the oil is flowed from the small diameter section 3002 to the large diameter section 3001, the outlet pressure of the oil from the large diameter section 3001 may be larger and the dust may be not accumulated in the connection pipe 300 easily. Through the movable fastener 3 which is disposed on the container 2 and can be detached to two pieces, the power cord 200 of the oil supply pump 100 is detachably fixed by the simplified structure and operation. It is convenient for use and storage. The oil suction device of the present invention has a simplified structure and the operation of the oil suction device is convenient.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. An oil suction device, comprising:
a container, outside of the container having a first accommodation trough for accommodating an oil supply pump and a second accommodating trough for accommodating a connection pipe, an outlet of the oil supply pump is fluidly communicated with an inside of the container and an inlet thereof is fluidly communicated with the connection pipe; and
a plurality of movable fasteners, each movable fastener having a male buckle and a female buckle to engage with each other, the male buckle being fixed on one side of the container close to the accommodation trough, the male buckle having a first base and a plurality of protrusions, each protrusion extending upward from a central portion of the first base, the protrusions being spaced at an equal angle, one end of each protrusion, opposite to the first base, being formed with a tapered shoulder, the female buckle having a second base, an annular buckle and a holding member, the second base having an opening for insertion of the protrusions of the male buckle, the tapered shoulder of each protrusion being detachably connected to the opening, one end of the annular buckle being fixed to one side of the second base, another end of the annular buckle being suspended and formed with a first hook, the holding member being disposed on the second base, close to the first hook of the annular buckle, one side of the holding member, close to the first hook, having a second hook, the first hook being detachably engaged with the second hook.

2. The oil suction device as claimed in claim 1, wherein the annular buckle of the male buckle is detachable for fixing at least one power cord of the oil supply pump and an oil pipe.

3. The oil suction device as claimed in claim 1, wherein the connection pipe includes a large diameter section and a small diameter section fluidly communicated with each other, one end of the large diameter section opposite to the small diameter section is fluidly communicated with the inlet of the oil supply pump and the other end thereof opposite to the oil pump is fluidly communicated with the small diameter section.
